(19) United States
(12) Patent Application Publication
(10) Pub. No.: US 2014/0309752 A1
(43) Pub. Date: Oct. 16, 2014

(54) DEVICE CONTROL SYSTEM, DEVICE CONTROL METHOD, AND COMPUTER-READABLE RECORDING MEDIUM

(71) Applicants: Hajime Yuzurihara, Kanagawa (JP); Takeo Tsukamoto, Kanagawa (JP); Takanori Inadome, Kanagawa (JP); Hideaki Aratani, Kanagawa (JP)

(72) Inventors: Hajime Yuzurihara, Kanagawa (JP); Takeo Tsukamoto, Kanagawa (JP); Takanori Inadome, Kanagawa (JP); Hideaki Aratani, Kanagawa (JP)

(21) Appl. No.: 14/361,606

(22) PCT Filed: Nov. 9, 2012
(86) PCT No.: PCT/JP2012/079719

§ 371 Date: May 29, 2014

(30) Foreign Application Priority Data
Nov. 29, 2011 (JP) 2011-260939
Jun. 22, 2012 (JP) 2012-141371

(51) Int. Cl. G05B 15/02

(52) U.S. Cl. CPC G05B 15/02
USPC 700/13; 700/66

(57) ABSTRACT

A device control system includes a positioning apparatus and a control apparatus connected to the positioning apparatus through a network. The positioning apparatus includes a receiver configured to receive detection data from an acceleration sensor, an angular velocity sensor, and a geomagnetic sensor that are carried by a person; a position identifying unit configured to identify a position of the person in a control target area based on the detection data; an action-state detecting unit configured to detect an action state of the person based on the detection data; and a transmitter configured to transmit the identified position and the detected action state to the control apparatus. The control apparatus includes a device control unit configured to control a device arranged in the control target area based on the position and the action state of the person.

### TECHNICAL FIELD

The present invention relates to a device control system, a device control method, and a computer-readable recording medium.

### BACKGROUND ART

Controlling power on and off of a lighting device using an action sensor is generally performed as a technique for achieving energy saving by detecting one or more persons without identifying the persons. Meanwhile, a technique using a radio frequency identification (RFID) tag is generally known as a technique for identifying and positioning a person. These techniques make it possible to detect whether there is one or more persons in an indoor area such as a building or an office and identify the persons, thereby determining the number of persons. These techniques further make it possible to control a controlled device appropriately on a person-by-person basis by storing control conditions in the controlled device in advance.

An example of such a technique is disclosed in Japanese Patent No. 4640286. This technique increases energy efficiency by positioning a person and controlling power-on/off of an air conditioner and a lighting device provided in a space near the person, and provides comfort to the person by adjusting a direction in which air is blown by the air conditioner. According to this technique, the person is positioned three-dimensionally using infrared detectors or ultrasonic detectors arranged on walls, ceiling, and/or the like.

Another example technique is disclosed in Japanese Patent No. 4044472. According to this technique, a unique identification (ID) code is assigned to each of persons that enter a room. A plurality of detection units for detecting a detected object attached to a person that enters the room are arranged at fixed intervals on the floor of the room. The person that has entered the room is positioned by detecting the ID code. Personal condition data that contains the ID code and an air conditioning condition associated with the ID code is read out to operate an air conditioner in the air conditioning condition suitable for the person.

Other known techniques include that that detects the position of a person using an RFID tag and predicts a next position of the person based on history positional data about the person, thereby controlling an air-conditioning device efficiently and in a manner to provide comfort. An example of this technique is disclosed in Japanese Patent Application Laid-open 2009-250589.

However, the conventional technique using the action sensor is disadvantageous in that the person is position in a precision of several meters, which is undesirably relatively large. In addition, this technique causes, when a person is in a resting state for a long period of time, an erroneous recognition that there is no person to be made and power supply to a device to be inappropriately cut off.

The conventional technique using the RFID tag is also disadvantageous in that to achieve a high precision of one meter or less in detection, it is necessary to arrange a large number of readers that receive a signal from the RFID tag. In addition, the technique using the RFID tag is disadvantageous in that if there is an obstacle, the detection precision decreases.

Meanwhile, when a ultrasonic method is employed, it is necessary to arrange a large number of detectors to increase precision in detection.

Reduction of CO₂ emissions is currently fostered world wide. There is also a trend of transition from building new nuclear power plants to renewable energies independent of nuclear power. Against this backdrop, additional power saving and energy saving will be desired in the future. To achieve them, manually switching on and off devices with consciousness of eliminating useless consumption at all times is required. However, it is substantially impracticable that every worker in an office, a plant, or the like switches on and off devices with such consciousness at all times.

This has created a demand for power saving based on human consciousness plus power saving by automatic control. A system that not only enables power control of devices with finer precision but also provides workers with comfort and enhances work efficiency, which have been unattainable with conventional techniques, is desired.

### DISCLOSURE OF INVENTION

It is an object of the present invention to at least partially solve the problems in the conventional technology.

According to an embodiment, there is provided a device control system includes a positioning apparatus configured to detect a position and an action state of at least one person in a control target area; and a control apparatus configured to control a device arranged in the control target area, the control apparatus being connected to the positioning apparatus through a network. The positioning apparatus includes a first receiver configured to receive detection data from an acceleration sensor, an angular velocity sensor, and a geomagnetic sensor that are carried by the person; a position identifying unit configured to identify a position of the person in the control target area based on the detection data; an action-state detecting unit configured to detect an action state of the person based on the detection data; and a transmitter configured to transmit the identified position and the detected action state to the control apparatus. The control apparatus includes a second receiver configured to receive the position and the action state of the person from the positioning apparatus; and a device control unit configured to control the device based on the position and the action state of the person.

According to another embodiment, there is provided a device control method is performed by a device control system that includes a positioning apparatus configured to detect a position and an action state of at least one person in a control target area, and a control apparatus configured to control a device arranged in the control target area, the control apparatus being connected to the positioning apparatus through a network. The device control method includes receiving, by the positioning apparatus, detection data from an acceleration sensor, an angular velocity sensor, and a geomagnetic sensor that are carried by the person; identifying, by the positioning apparatus, a position of the person in the control target area based on the detection data; detecting, by the positioning apparatus, an action state of the person based on the detection data; transmitting, by the positioning apparatus, the identified position and the detected action state to the control apparatus; receiving, by the control apparatus, the position and the action state of the person from the positioning apparatus; and controlling, by the control apparatus, the device based on the position and the action state of the person.

According to still another embodiment, there is provided a computer-readable recording medium with an executable program stored thereon. The program instructs a computer that detects a position and an action state of at least one person in a control target area, to perform receiving detection data from an acceleration sensor, an angular velocity sensor, and a geomagnetic sensor that are carried by the person; identifying a position of the person in the control target area based on the detection data; detecting an action state of the person based on the detection data; and transmitting the identified position and the detected action state to a control apparatus that is connected to the computer through a network and controls a device in the control target area.

The above and other objects, features, advantages and technical and industrial significance of this invention will be better understood by reading the following detailed description of presently preferred embodiments of the invention, when considered in connection with the accompanying drawings.

### BRIEF DESCRIPTION OF DRAWINGS

FIG. 1 is a network configuration diagram of a device control system according to an embodiment of the present invention;

FIG. 2 is a diagram illustrating how and in which orientation a smartphone and sensors are worn by a person;

FIG. 3 is a diagram illustrating an example in which an information device capable of detecting actions of a person is worn by the person separately from the smartphone;

FIG. 4 illustrates directions detected by sensors;

FIG. 5 is a diagram illustrating an example of a layout of monitoring cameras;

FIG. 6 is a diagram illustrating an example of a layout of LED lighting devices, outlet power strips, and air conditioners;

FIG. 7 is a block diagram illustrating a functional configuration of a positioning server;

FIG. 8 is a graph of a vertical acceleration component produced by a sit-down action and a stand-up action performed in sequence;

FIG. 9 is a graph of a horizontal angular velocity component produced by a squat action and a stand-up action performed in sequence;

FIG. 10 is a graph of a vertical angular velocity component produced by an orientation-change action in a resting state;

FIG. 11 is a graph of a horizontal angular velocity component pertaining to the head of a person that turns his/her eyes up away from a display in a sitting state;

FIG. 12 is a graph of a horizontal angular velocity component pertaining to the head of a person that turns his/her eyes down away from a display in a sitting state;

FIG. 13 is a block diagram illustrating a functional configuration of a control server according to the present embodiment;

FIG. 14 is a flowchart illustrating a procedure of a detection process to be performed by the positioning server according to the present embodiment;

FIG. 15 is a flowchart illustrating a procedure of a device control process according to the present embodiment; and

FIG. 16 is a diagram for comparison between Examples and Comparative Examples.

### BEST MODE(S) FOR CARRYING OUT THE INVENTION

Exemplary embodiments of the present invention are described in detail below with reference to the accompanying drawings.

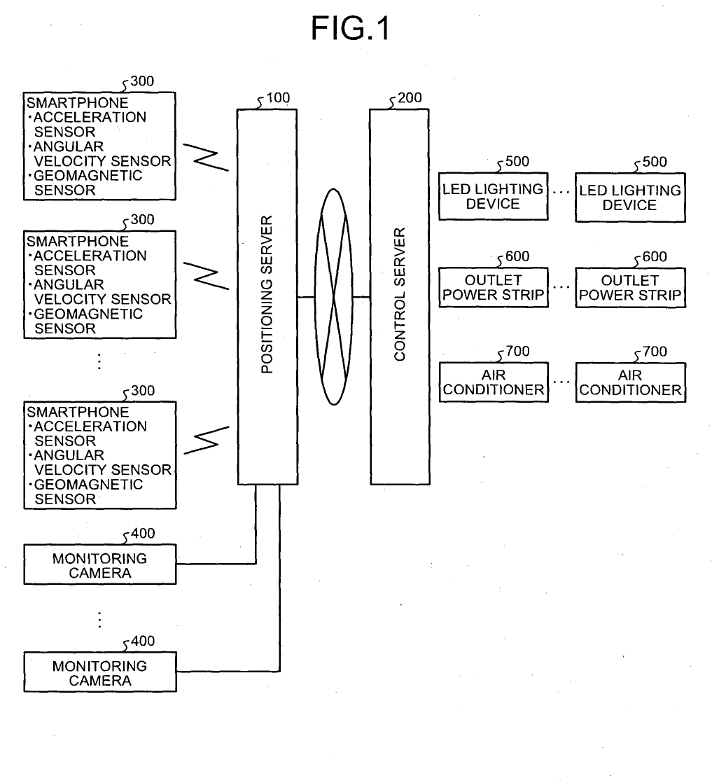

FIG. 1 is a network configuration diagram of a device control system according to an embodiment of the present invention. As illustrated in FIG. 1, the device control system according to the embodiment includes a plurality of smartphones 300, a plurality of monitoring cameras 400 as image capturing devices, a positioning server 100, a control server 200, a plurality of light-emitting diode (LED) lighting devices 500, a plurality of outlet power strips 600, and a plurality of air conditioners 700. The devices 500, 600, and 700 are to be controlled.

The plurality of smartphones 300, the plurality of monitoring cameras 400, and the positioning server 100 are connected through a wireless communication network of, for example, Wi-Fi (registered trademark) connections. Note that an employable wireless communication method is not limited to Wi-Fi. The monitoring cameras 400 and the positioning server 100 may alternatively be wire-connected.

The positioning server 100 and the control server 200 are connected to each other through a network such as the Internet or a local area network (LAN).

The plurality of LED lighting devices 500, the plurality of outlet power strips 600, and the plurality of air conditioners 700 are connected to the control server 200 through a wireless communication network of, for example, Wi-Fi connections.

The method for communications between the control server 200, and the plurality of LED lighting devices 500, the plurality of outlet power strips 600, and the plurality of air conditioners 700 is not limited to Wi-Fi, but another wireless communication method can be utilized. Further alternatively, a wired communication method using Ethernet (registered trademark) cables, power line communications (PLC), or the like can be utilized.

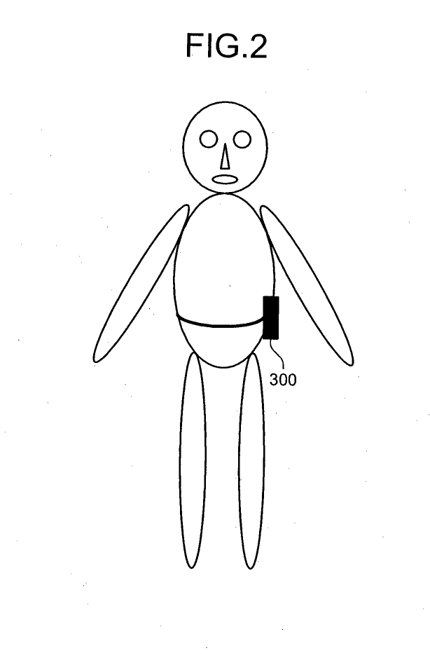

The smartphone 300 can function as an information device that is to be carried by a person and detects an action of the person. FIG. 2 is a diagram illustrating how the smartphone 300 is worn by a person. The smartphone 300 may be carried by a hand or the like of a person, or, alternatively, worn at the waist of the person as illustrated in FIG. 2.

Referring back to FIG. 1, each of the smartphones 300 includes an acceleration sensor, an angular velocity sensor, and a geomagnetic sensor and transmits detection data output from each of the sensors to the positioning server 100 at fixed time intervals, e.g., every second. The detection data output from the acceleration sensor is an acceleration vector. The detection data output from the angular velocity sensor is an angular velocity vector. The detection data output from the geomagnetic sensor is a magnetic vector.

In the present embodiment, the smartphone 300 is used as an information device that detects an action of a person. However, the information device is not limited to a portable terminal such as the smartphone 300, and can be any information device that includes an acceleration sensor, an angular velocity sensor, and a geomagnetic sensor and is capable of detecting an action of a person.

A configuration in which an information device such as the acceleration sensor, the angular velocity sensor, and the geomagnetic sensor for detecting an action of a person is contained in the smartphone 300, and another information device for detecting an action of the person is worn by the person separately from the smartphone 300 can be employed.

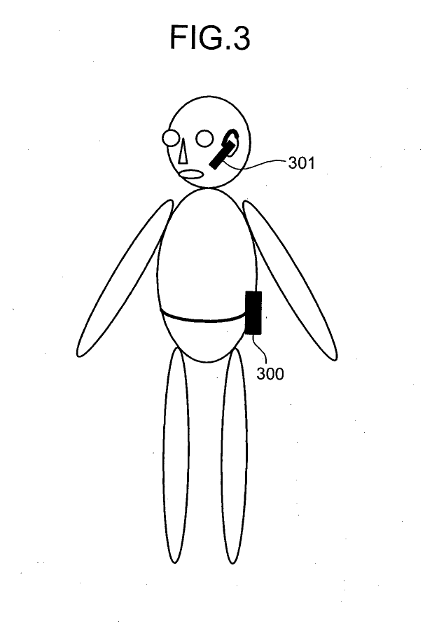

FIG. 3 is a diagram illustrating an example in which an information device capable of detecting actions of a person is worn by the person separately from the smartphone 300. As illustrated in FIG. 3, a small headset-type sensor group 301 that includes an acceleration sensor, an angular velocity sensor, and a geomagnetic sensor can be worn at the head of the person separately from the smartphone 300. In this case, detection data obtained by the sensor group 301 can be directly transmitted from the sensor group 301 to the positioning server 100. Alternatively, the detection data may be transmitted to the positioning server 100 via the smartphone 300. When the sensor group 301 is worn at the head of the person separately from the sensors of the smartphone 300, a variety of postures can be detected.

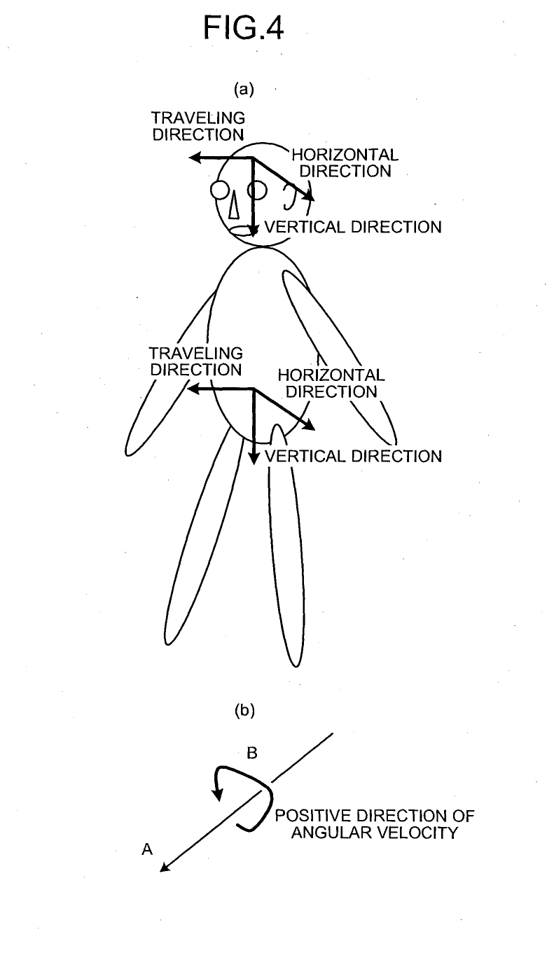

FIG. 4 illustrates directions detected by the sensors. Illustrated in (a) of FIG. 4 are directions detected by the acceleration sensor and the geomagnetic sensor. As illustrated in (a) of FIG. 4, acceleration components in a traveling direction, the vertical direction, and the horizontal direction are detectable using the acceleration sensor; geomagnetic field components in the traveling direction, the vertical direction, and the horizontal direction are detectable using the geomagnetic sensor. Illustrated in (b) of FIG. 4 is an angular velocity vector A detected by the angular velocity sensor. In (b) of FIG. 4, the positive direction of the angular velocity is indicated by an arrow B. In the present embodiment, a projection of the angular velocity vector A in the traveling direction, a projection of the same in the vertical direction, and a projection of the same in the horizontal direction in (a) of FIG. 4 are referred to as an angular velocity component in the traveling direction, a vertical angular velocity component, and a horizontal angular velocity component, respectively.

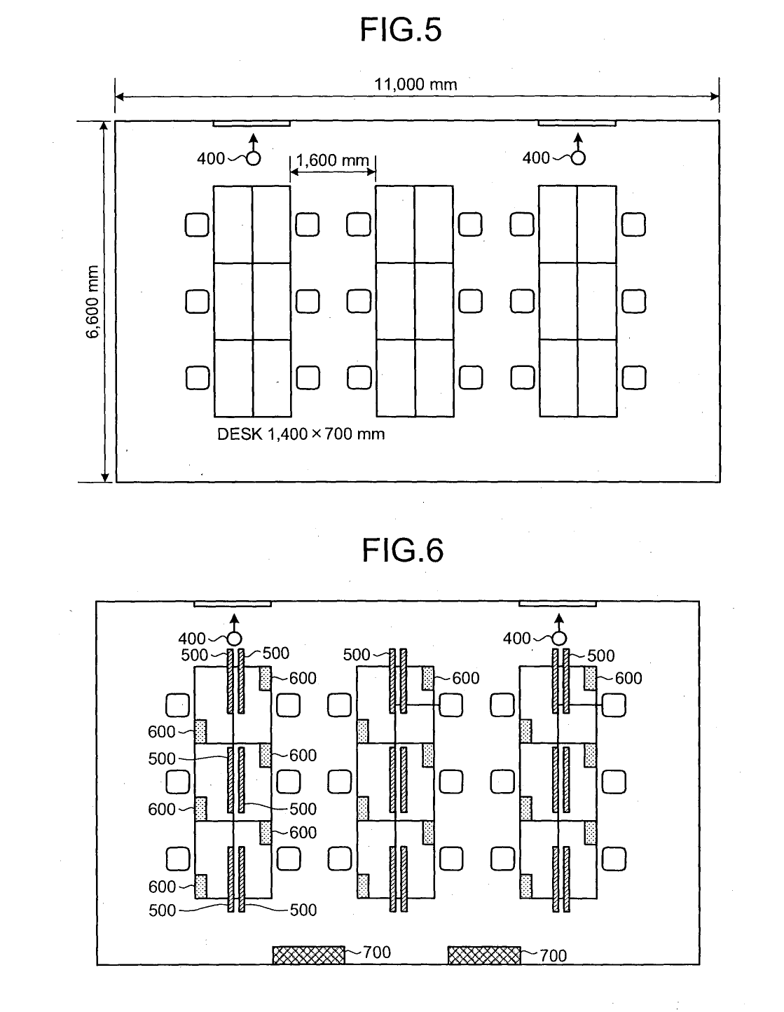

Referring back to FIG. 1, the monitoring cameras 400 that capture images of interior of a room which is a control target area are arranged near a top portion or the like of the room which is the control target area. FIG. 5 is a diagram illustrating an example of a layout of the monitoring cameras 400. In the example illustrated in FIG. 5, the monitoring cameras 400 are arranged in the room at two points near doors; however, the layout is not limited to thereto. Each of the monitoring cameras 400 captures images of the interior of the room which is the control target area and transmits the captured images (captured video) to the positioning server 100.

Referring back to FIG. 1, the power control targets in the present embodiment include a lighting system, an outlet power strip system, and an air-conditioning system. More specifically, the power control targets include the plurality of LED lighting devices 500 as the lighting system, the plurality of outlet power strips 600 as the outlet power strip system, and the plurality of air conditioners 700 as the air-conditioning system.

The plurality of LED lighting devices 500, the plurality of outlet power strips 600, and the plurality of air conditioners 700 are installed in the room which is the control target area. FIG. 6 is a diagram illustrating an example of a layout of the LED lighting devices 500, the outlet power strips 600, and the air conditioners 700.

As illustrated in FIG. 6, the room contains three groups each consisting of six desks. Each desk is provided with one of the LED lighting devices 500 and one of the outlet power strips 600. By contrast, each of the air conditioners 700 is arranged so as to be shared between two groups of the groups. This layout of the LED lighting devices 500, the outlet power strips 600, and the air conditioners 700 is merely an example, and an employable layout is not limited to the example illustrated in FIG. 6.

Information about a sum total of power consumptions in the room of the present embodiment can be obtained from a utility-grid power meter (not shown in FIG. 6) arranged outside the room.

Eighteen users are performing specific business activities in the room. Each user enters and leaves the room by any one of two doors. In the present embodiment, the layout, the devices, the number of users, and the like are defined; however, applicable applications include various layouts and devices. Furthermore, this device control is highly-flexibly adaptable to a wide range of space size and the number of users, and wide range of user attributes and business types of individual users or groups of users. Application is not limited to an indoor space such as is illustrated in FIGS. 5 and 6, and the present embodiment may be applied to outdoor or the like.

The positioning server 100 and the control server 200 according to the present embodiment are arranged outside the room illustrated in FIGS. 5 and 6. The positioning server 100 and the control server 200 can alternatively be arranged in the room which is the control target area to be included in the subjects of the power control.

In the present embodiment, network devices such as a Wi-Fi access point, a switching hub, and a router contained in a communication network system are excluded from the power control targets; however, they may be included in the power control targets.

Meanwhile, power consumption of these network devices can be calculated by subtracting a sum of power consumptions of the LED lighting devices 500, the air conditioners 700, and the outlet power strips 600 from the total power consumption.

The control server 200 operates each of the plurality of LED lighting devices 500, the plurality of outlet power strips 600, and the plurality of air conditioners 700 by remote control through the network.

Specifically, the control server 200 sets illuminating ranges and illuminances of the LED lighting devices 500 by remote control. More specifically, the LED lighting devices 500 have on-off switches that are individually remote controllable. The control server 200 wirelessly switches on and off the LED lighting devices 500 through Wi-Fi radio connections. Each of the LED lighting devices 500 utilizes an LED lamp with a dimming feature because of its low power consumption, and is configured such that the dimming feature is also remote controllable through the Wi-Fi connection.

The lighting system is not limited to the LED lighting devices 500. For example, incandescent lamps, fluorescent lamps, or the like can alternatively be used.

The control server 200 switches on and off the air conditioners 700 by remote control. More specifically, the air conditioners 700 are configured to be individually remote controllable. The items to be controlled include not only power-on/off of each of the air conditioners 700 but also a direction and intensity of air to be blown by the air conditioner 700. The temperature and the humidity of the air to be blown are not controlled in the present embodiment. However, the items to be controlled are not limited to those of the present embodiment, and the temperature and the humidity may be included in the items to be controlled.

Each of the outlet power strips 600 includes a plurality of outlets. The control server 200 switches on and off each of the outlets by remote control. More specifically, each of the outlet power strip 600 includes on/off switches that are remote controllable on a outlet-by-outlet basis. The control server 200 wirelessly performs on/off control of the outlet power strips 600 through the Wi-Fi radio connections. The number of the outlets contained in one of the outlet power strips 600 can be an arbitrary number. For example, a four-outlet power strip can be used.

As illustrated in FIG. 6, each desk is provided with one of the outlet power strips 600. Electrical devices (not shown) are connectable to the outlet power strips 600. Concrete examples of the electrical devices include desktop PCs, display devices, notebook PCs, printer apparatuses, and battery chargers.

In the present embodiment, an electrical plug of a display device, for which relationship in orientation between a user and the display device matters greatly, is connected to one of the outlets of the outlet power strip 600. The control server 200 can control the display device by switching power supply to the outlet on and off.

However, when a desktop PC body or a printer apparatus is connected to an outlet of the outlet power strip 600, the control server 200 cannot control the desktop PC body or the printer apparatus by switching power supply to the outlet on and off for structural reasons of these apparatuses. Accordingly, power-saving control for the desktop PC body is preferably performed using control software installed in advance. The control software allows placing the desktop PC body in a power-saving mode or a shut-down state via the network. Recovery of the desktop PC body from the power-saving mode or the shut-down state is to be made by a manual operation performed by a user.

When a battery charger or a notebook PC is connected to the outlet power strip 600 for recharging, power is preferably continuously supplied to the outlet to which the battery charger or the notebook PC is connected for convenience. Note that devices to be connected to the outlets of the outlet power strips 600 are not limited to these devices described above.

Referring back to FIG. 1, the positioning server 100 receives the detection data output from the sensors, detects the position of the person that is wearing the sensors and detects an action state of the person, and transmits the position and the action state to the control server 200.

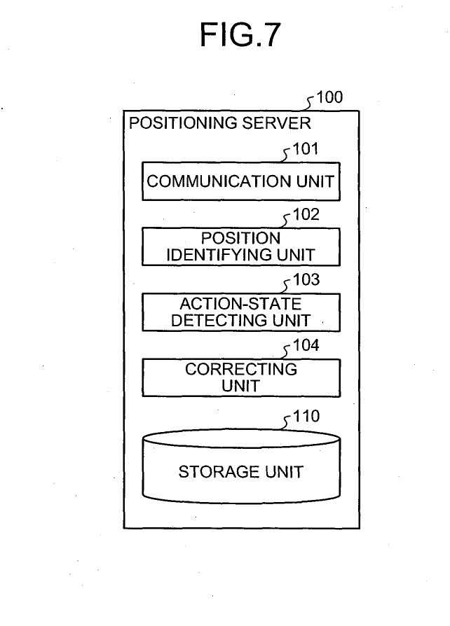

FIG. 7 is a block diagram illustrating a functional configuration of the positioning server 100. As illustrated in FIG. 7, the positioning server 100 includes a communication unit 101, a position identifying unit 102, an action-state detecting unit 103, a correcting unit 104, and a storage unit 110.

The storage unit 110 is a storage medium such as a hard disk drive (HDD) or a memory. The storage unit 110 stores map data about a layout in the room which is the control target area.

The communication unit 101 receives detection data from each of the acceleration sensor, the angular velocity sensor, and the geomagnetic sensor mounted on the smartphone 300 or the acceleration sensor, the angular velocity sensor, and the geomagnetic sensor of the sensor group 301 which is independent from the smartphone 300. More specifically, the communication unit 101 receives acceleration vectors from the acceleration sensors, angular velocity vectors from the angular velocity sensors, and magnetic vectors from the geomagnetic sensors.

The communication unit 101 also receives captured images from the monitoring cameras 400. The communication unit 101 transmits the action state, which will be described later, including an absolute position, an orientation, and a posture of the person to the control server 200.

The position identifying unit 102 identifies the absolute position of the person in a precision of shoulder breadth or step length of the person by analyzing the received detection data. A method by which the position identifying unit 102 identifies the absolute position of the person will be described in detail later.

The action-state detecting unit 103 detects the action state of the person by analyzing the received detection data. In the present embodiment, the action-state detecting unit 103 detects which one of a resting state and a walking state the action state of the person is. When the action state is the resting state, the action-state detecting unit 103 further detects an orientation of the person relative to a device in the control target area and which one of a standing state and a sitting state the posture of the person is based on the detection data.

More specifically, when the action-state detecting unit 103 detects that the person has entered by one of the doors based on the captured images fed from the monitoring cameras 400, the action-state detecting unit 103 constantly determines which one of the walking state and the resting state the action state of the person is using time series data about the acceleration vector and time series data about the angular velocity vector among the detection data constantly received from the acceleration sensor, the angular velocity sensor, and the geomagnetic sensor of the smartphone 300 worn by the person entering the room or the acceleration sensor, the angular velocity sensor, and the geomagnetic sensor of the sensor group 301 which is independent from the smartphone 300. Meanwhile, the method for determining which one of the walking state and the resting state the action state of the person is using the acceleration vector and the angular velocity vector can be implemented using a technique related to a dead reckoning device disclosed in Japanese Patent No. 4243684. When the person is determined not to be in the walking state with this method, the action-state detecting unit 103 determines that the person is in the resting state.

More specifically, the action-state detecting unit 103 detects the action state of the person as follows in a manner similar to that performed by the dead reckoning device disclosed in Japanese Patent No. 4243684.

The action-state detecting unit 103 calculates a gravitational acceleration vector from the acceleration vector received from the acceleration sensor and the angular velocity vector received from the angular velocity sensor. The action-state detecting unit 103 then subtracts the gravitational acceleration vector from the acceleration vector to remove the acceleration in the vertical direction, thereby obtaining time-series remainder-acceleration-component data. The action-state detecting unit 103 performs principal component analysis of the time-series remainder-acceleration-component data, thereby determining a traveling direction of a walk action. Furthermore, the action-state detecting unit 103 searches the vertical acceleration component for a pair of a peak and a valley, and searches the acceleration component in the traveling direction for a pair of a peak and a valley. The action-state detecting unit 103 calculates a gradient of the acceleration component in the traveling direction.

The action-state detecting unit 103 then determines whether a gradient of the acceleration component in the traveling direction at time when the valley of a declining portion from the peak to the valley of the vertical acceleration component is detected is equal to or greater than a predetermined value. When the gradient is equal to or greater than the predetermined value, the action-state detecting unit 103 determines that the action state of the person is the walking state.

On the other hand, the action-state detecting unit 103 determines that the action state of the person is the resting state when a pair of a valley and a peak is not found in at least one of the vertical acceleration component and the acceleration component in the traveling direction, or when the gradient of the acceleration component in the traveling direction at the time when the valley of the declining portion of the vertical acceleration component is detected is smaller than the predetermined value in the process described above.

When the person is determined to be in the resting state, the position identifying unit 102 calculates a relative displacement vector using the acceleration vector, the angular velocity vector, and the magnetic vector with respect to a reference position, which is the position of the door, to a position where the person is determined to be in the resting state. Calculation of the relative displacement vector using the acceleration vector, the angular velocity vector, and the magnetic vector is preferably performed using a method of a dead reckoning device disclosed in Japanese Patent Application Laid-open No. 2011-47950.

More specifically, the position identifying unit 102 obtains the relative displacement vector as follows in a manner similar to that performed by the dead reckoning device disclosed in Japanese Patent Application Laid-open No. 2011-47950.

More specifically, the position identifying unit 102 calculates a gravity direction vector from the acceleration vector received from the acceleration sensor and the angular velocity vector received from the angular velocity sensor. The position identifying unit 102 then calculates an attitude angle of the person as a displacement direction from the gravity direction vector and any one of the angular velocity vector and the magnetic vector received from the geomagnetic sensor. The position identifying unit 102 also obtains a gravitational acceleration vector from the acceleration vector and the angular velocity vector, and then calculates an acceleration vector produced by the walk action from the gravitational acceleration vector and the acceleration vector. The position identifying unit 102 then analyzes the walk action based on the gravitational acceleration vector and the acceleration vector produced by the walk action to obtain an analysis result. The position identifying unit 102 calculates a magnitude of the walk action based on the analysis result to determine a step length. The position identifying unit 102 obtains the relative displacement vector with respect to the reference position by integrating the displacement direction and the step length obtained as described above. In other words, the position identifying unit 102 positions the person in real time in the precision of the step length or the shoulder breadth which is approximately 60 cm or smaller (more specifically, approximately 40 cm or smaller), for example, of the person.

When the relative displacement vector has been calculated as described above, the position identifying unit 102 identifies an absolute position to which the person has traveled based on the relative displacement vector with respect to the door and the room map data stored in the storage unit 110.

Thus, the position identifying unit 102 can identify at which one of the desks arranged in the room the person is. Accordingly, the position identifying unit 102 is capable of identifying the position of the person in the precision of the step length or the shoulder breadth which is approximately 60 cm or smaller (more specifically, approximately 40 cm or smaller), for example, of the person.

There is no specific requirement (e.g., a precision in the order of one centimeter) for such a positional precision because the higher the positional precision, the better. In a situation where, for example, two or more persons are having conversation, they are rarely in contact with each other but generally a certain distance away from each other. In the present embodiment, it is assumed that an appropriate precision in determination as to which one of the desks is where the person is present is approximately the shoulder breadth or the step length of the person; an appropriate precision in determination as to whether the person is standing or sitting is approximately the length from the waist to the knees of the person.

The anthropometric data (Makiko Kouchi, Masaaki Mochimaru, Hiromu Iwasawa, and Seiji Mitani, 2000: Anthropometric database for Japanese Population 1997-98, Japanese Industrial Standards Center (AIST, MITI)) released by the Ministry of Health, Labour and Welfare, contains data about biacromial breadths, which correspond to shoulder breadths, of young adult and elderly men and women. According to this data, an average shoulder breadth of elderly women, which is the smallest among averages, is approximately 35 cm (34.8 cm), while an average shoulder breadth of young adult men, which is the greatest among the averages, is approximately 40 cm (39.7 cm). According to the anthropometric data, lengths from waists to knees (differences between suprasternal heights and lateral epicondyle heights) are approximately 34 to 38 cm. Meanwhile, persons take approximately 95 steps to walk 50 m. Accordingly, step length of moving persons can be calculated as approximately 53 (=50/95×10) cm. The positioning method employed in the present embodiment can achieve the precision of this step length. Therefore, based on this data, the present embodiment is configured on an assumption that the precision of 60 cm or smaller, more preferably 40 cm or smaller, is appropriate. The data referred to here can be used as reference data in determination of the precision; however, this data is based on measurements performed on Japanese people, and employable reference data is not limited to these numerical values.

When the absolute position of the person is identified and the person is determined to be in the resting state at a seat of a desk, the action-state detecting unit 103 determines a direction (orientation) of the person relative to the display device based on a direction of the magnetic vector received from the geomagnetic sensor. When the person is determined to be in the resting state at the seat of the desk, the action-state detecting unit 103 determines a posture of the person, or, more specifically, whether the person is in the standing state or the sitting state, based on the vertical acceleration component of the acceleration vector.

The determination as to whether the person is in the standing state or the sitting state is preferably determined in a manner similar to that performed by the dead reckoning device disclosed in Japanese Patent No. 4243684. More specifically, a gravitational acceleration vector is calculated from the acceleration vector received from the acceleration sensor and the angular velocity vector received angular velocity sensor, thereby obtaining the vertical acceleration component. The action-state detecting unit 103 then detects a peak and a valley of the vertical acceleration component in a manner similar to that performed by the dead reckoning device disclosed in Japanese Patent No. 4243684.

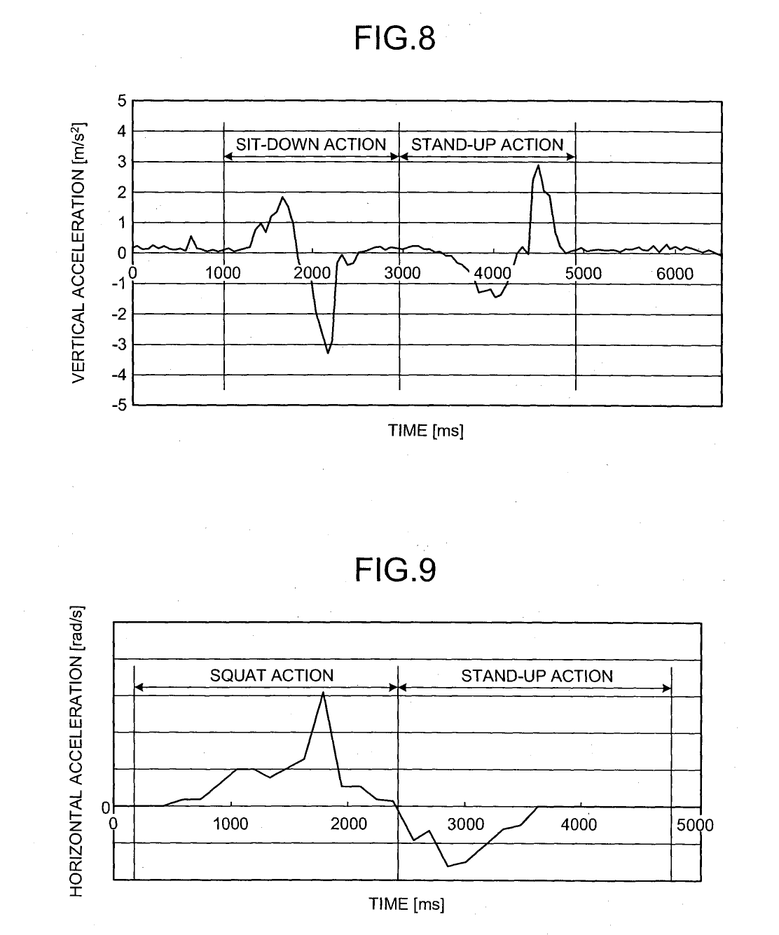

FIG. 8 is a graph of a vertical acceleration component produced by a sit-down action and a stand-up action performed in sequence. As illustrated in FIG. 8, a peak-to-valley period of the vertical acceleration component produced by the sit-down action is approximately 0.5 seconds. A valley-to-peak period of the vertical acceleration component produced by the stand-up action is approximately 0.5 seconds. Accordingly, the action-state detecting unit 103 determines whether the person is in the sitting state or the standing state based on these peak-to-valley/valley-to-peak periods. More specifically, the action-state detecting unit 103 determines that the action state of the person is the sitting state when the peak-to-valley period of the vertical acceleration component is within a predetermined range from 0.5 seconds. The action-state detecting unit 103 determines that the action state of the person is the standing state when the valley-to-peak period of the vertical acceleration component is within a predetermined range from 0.5 seconds.

As described above, the action-state detecting unit 103 determines whether the action state of the person is the standing state or the sitting state, thereby detecting a vertical position of the person in the precision of approximately 50 cm or smaller (more specifically, approximately 40 cm or smaller).

Furthermore, the action-state detecting unit 103 can further detect a posture and an action described below when the person wears the smartphone 300 equipped with the information device such as the acceleration sensor, the angular velocity sensor, and the geomagnetic sensor for detecting actions of a person at the waist, and, in addition, the small headset-type sensor group 301 that includes the acceleration sensor, the angular velocity sensor, and the geomagnetic sensor at the head separately from the smartphone 300 as in the example illustrated in FIG. 3.

FIG. 9 is a graph of a horizontal angular velocity component produced by a squat action and a stand-up action performed in sequence. A waveform similar to that of the graph of the sit-down action and the stand-up action illustrated in FIG. 8 is observed in a plot of acceleration data output from the acceleration sensor. However, it is difficult to discriminate between the squat action and the stand-up action based on only the acceleration data.

For this reason, the action-state detecting unit 103 discriminates between the squat action and the stand-up action by, in addition to using the method described above for discriminating between the sit-down action and the stand-up action based on the waveform illustrated in FIG. 8, determining whether variation with time of horizontal angular velocity data received from the angular velocity sensor matches the waveform illustrated in FIG. 9.

More specifically, the action-state detecting unit 103 determines whether a peak-to-valley period of the vertical acceleration component received from the acceleration sensor is within a predetermined range from 0.5 seconds first.

When the peak-to-valley period of the vertical acceleration component is within the predetermined range from 0.5 seconds, the action-state detecting unit 103 determines whether a horizontal angular velocity component of the angular velocity vector received from the angular velocity sensor varies within approximately 2 seconds to form a waveform such as is illustrated in FIG. 9 where the horizontal angular velocity component gradually increases from zero, thereafter sharply increases to reach the peak, then sharply decreases from the peak, and thereafter gradually decreases to become zero again. If so, the action-state detecting unit 103 determines that the action of the person is the squat action.

The action-state detecting unit 103 determines whether a valley-to-peak period of the vertical acceleration component is within the predetermined range from 0.5 seconds. When the valley-to-peak period of the vertical acceleration component is within the predetermined range from 0.5 seconds, the action-state detecting unit 103 determines whether the horizontal angular velocity component of the angular velocity vector received from the angular velocity sensor varies within approximately 1.5 seconds to form a waveform such as is illustrated in FIG. 9 where the horizontal angular velocity component decreases from zero to reach a valley in stages and gradually increases from the valley to become zero again. If so, the action-state detecting unit 103 determines that the action of the person is the stand-up action.

As the angular velocity vector for use by the action-state detecting unit 103 to make this determination between the squat action and the stand-up action, the angular velocity vector received from the angular velocity sensor worn at the head is preferably used. This is because the angular velocity vector received from the angular velocity sensor worn at the head of the person performing the squat action and the stand-up action distinctively exhibits the waveform illustrated in FIG. 9.

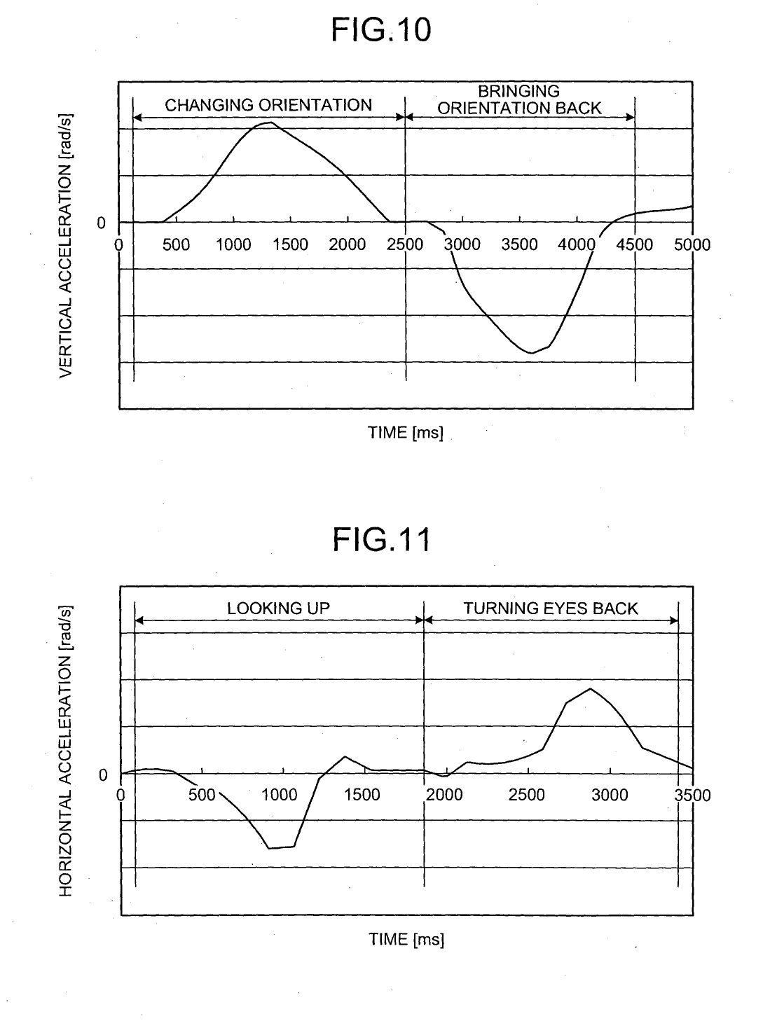

FIG. 10 is a graph of a vertical angular velocity component produced by an action of changing an orientation approximately 90 degrees of a person in the resting state. When the vertical angular velocity component is positive, an orientation-change action to the right is performed, while when the vertical angular velocity component is negative, an orientation-change action to the left is performed.

The action-state detecting unit 103 determines that an orientation-change action to the right is performed when the vertical angular velocity component of the angular velocity vector received from the angular velocity sensor varies with time within approximately 3 seconds to form a waveform such as is illustrated in FIG. 10 where the vertical angular velocity component gradually increases from zero to reach a peak and then gradually decreases to become zero again.

The action-state detecting unit 103 determines that an orientation-change action to the left is performed when the vertical angular velocity component varies with time within approximately 1.5 seconds to form a waveform such as is illustrated in FIG. 10 where the vertical angular velocity component gradually decreases from zero to reach a valley and then gradually increases to become zero again.

The action-state detecting unit 103 determines that an action of changing an orientation of an entire body to the right or the left is performed when each of the vertical angular velocity component of the angular velocity vector received from the angular velocity sensor at the head and that received from the angular velocity sensor of the smartphone 300 at the waist varies with time to form a waveform similar to that illustrated in FIG. 10.

On the other hand, the action-state detecting unit 103 determines that an action of changing an orientation of only the head to the right or the left is performed when although the vertical angular velocity component of the angular velocity vector received from the angular velocity sensor at the head varies with time to form a waveform similar to that illustrated in FIG. 10, the vertical angular velocity component of the angular velocity vector received from the angular velocity sensor of the smartphone 300 at the waist varies with time to form a waveform that is completely different from that illustrated in FIG. 10. Such an action can conceivably be made when a person changes his/her posture to have conversation with an adjacent user while staying seated, for example.

FIG. 11 is a graph of a horizontal angular velocity component of an angular velocity vector received from the angular velocity sensor at the head of a person that turns his/her eyes up away from a display in the sitting state.

A situation where the position identifying unit 102 has identified that an absolute position of the person is in front of a desk and the action-state detecting unit 103 has determined that the person at the desk is in the sitting state is assumed below. In this situation, the action-state detecting unit 103 determines that an action (looking-up action) of turning the person's eyes up away from the display in the sitting state is performed when the horizontal angular velocity component of the angular velocity vector received from the angular velocity sensor at the head of the person varies within approximately 1 second to form a waveform such as is illustrated in FIG. 11 where the horizontal angular velocity component gradually, decreases from zero to reach a valley and then sharply increases to become zero again. The action-state detecting unit 103 further determines that an action of turning the person's eyes back to the display from the state where the person has turned his/her eyes up away from the display in the sitting state is performed when the horizontal angular velocity component varies within approximately 1.5 seconds to form a waveform such as is illustrated in FIG. 11 where the horizontal angular velocity component gradually increases from zero to reach a peak and thereafter gradually decreases to become zero again.

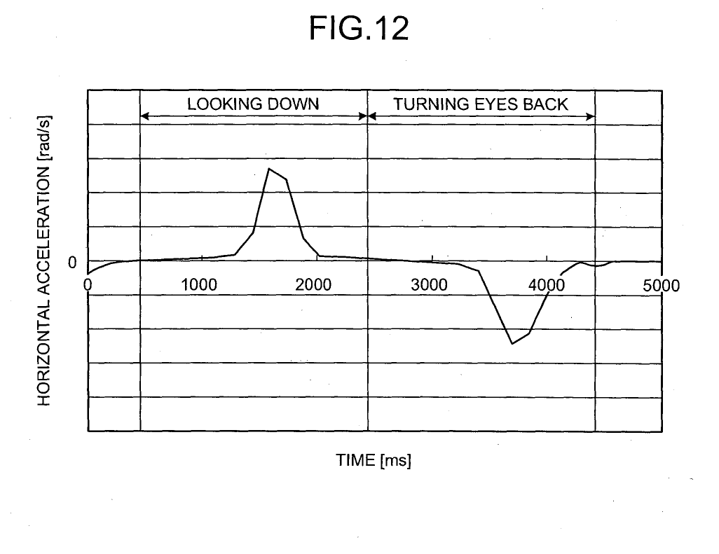

FIG. 12 is a graph of a horizontal angular velocity component of an angular velocity vector received from the angular velocity sensor at the head of a person that turns his/her eyes down away from a display in a sitting state.

A situation where the position identifying unit 102 has identified that an absolute position of the person is in front of a desk and the action-state detecting unit 103 has determined that the person at the desk is in the sitting state is assumed below. In this situation, the action-state detecting unit 103 determines that an action (looking-down action) of turning the person's eyes down away from the display in the sitting state is performed when the horizontal angular velocity component of the angular velocity vector received from the angular velocity sensor at the head of the person varies within approximately 0.5 seconds to form a waveform such as is illustrated in FIG. 12 where the horizontal angular velocity component sharply increases from zero to reach a peak and thereafter sharply decreases to become zero again.

The action-state detecting unit 103 further determines that an action of turning his/her eyes back to the display from the state where the person has turned his/her eyes up away from the display in the sitting state is performed when the horizontal angular velocity component varies within approximately 1 second to form a waveform such as is illustrated in FIG. 12 where the horizontal angular velocity component sharply decreases from zero to reach a valley and thereafter sharply increases to become zero again.

The action-state detecting unit 103 can make determination of postures and actions that can be daily taken by office workers using the methods described above. The postures and actions include walking (standing state), standing (resting state), sitting in a chair, squatting during a work, changing an orientation (direction) in the sitting state or the standing state, looking up in the sitting state or the standing state, and looking down in the sitting state or the standing state.

When the technique related to the dead reckoning device disclosed in Japanese Patent No. 4243684 is used, determination about an ascending or descending action of a person raised or lowered in an elevator is also made based on the vertical acceleration component as disclosed in Japanese Patent No. 4243684.

However, the action-state detecting unit 103 of the present embodiment uses a function provided by a map matching device disclosed in Japanese Patent Application Laid-open No. 2009-14713. Accordingly, the action-state detecting unit 103 can determine whether the person is performing the stand-up action or sit-down action highly accurately when a waveform such as is illustrated in FIG. 8 is obtained from the vertical acceleration component of a person at a position where no elevator is provided, in contrast to the dead reckoning device disclosed in Japanese Patent No. 4243684 that determines whether an ascending or descending action in an elevator is performed.

The correcting unit 104 corrects the identified absolute position and the detected action state (the orientation and the posture) based on the captured images fed from the monitoring cameras 400 and/or the map data stored in the storage unit 110. More specifically, the correcting unit 104 determines whether the absolute position, the orientation, and the posture of the person determined as described above are correct by performing image analysis of the captured images fed from the monitoring cameras 400 and the like and/or using the map data and the function provided by the map matching device disclosed in Japanese Patent Application Laid-open No. 2009-14713. When they are determined to be incorrect, the correcting unit 104 corrects them to a correct absolute position, a correct orientation, and a correct posture that are obtained from the captured images and/or the map matching function.

The correcting unit 104 does not necessarily perform the correction using the captured images fed from the monitoring cameras 400. Alternatively, the correcting unit 104 may be configured to perform the correction using short-range wireless communication such as RFID communication or Bluetooth (registered trademark), or optical communication.

In the present embodiment, the action state, the relative displacement vector, and the posture (the standing state or the sitting state) of the person are detected using the technique similar to the technique related to the dead reckoning device disclosed in Japanese Patent No. 4243684, that disclosed in Japanese Patent Application Laid-open No. 2011-47950, and the technique related to the map matching device disclosed in Japanese Patent Application Laid-open No. 2009-14713. However, an employable detection method is not limited thereto.

The control server 200 is described in detail below. The control server 200 operates each of the plurality of LED lighting devices 500, the plurality of outlet power strips 600, and the plurality of air conditioners 700 installed in the room which is the control target area by remote control through the network based on the position and the action state (the orientation and the posture) of the person in the room.

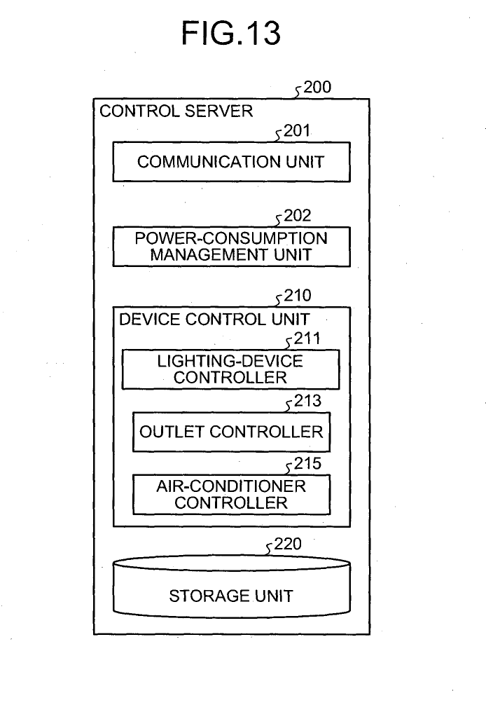

FIG. 13 is a block diagram illustrating a functional configuration of the control server 200 according to the present embodiment. As illustrated in FIG. 13, the control server 200 according to the present embodiment includes a communication unit 201, a power-consumption management unit 202, a device control unit 210, and a storage unit 220.

The storage unit 220 is a storage medium such as an HDD or a memory, and stores position data about the room which is the control target area.

The communication unit 201 receives information about the absolution position and the action (the orientation and the posture) of the person from the positioning server 100. The communication unit 201 also receives power consumption data from the plurality of LED lighting devices 500, electrical devices connected to the plurality of outlet power strips 600, and the plurality of air conditioners 700. The communication unit 201 transmits control signals for power control to the plurality of LED lighting devices 500, the plurality of outlet power strips 600, and the plurality of air conditioners 700.

The power-consumption management unit 202 manages the power consumption data received from the plurality of LED lighting devices 500, the electrical devices connected to the plurality of outlet power strips 600, and the plurality of air conditioners 700.

The device control unit 210 includes a lighting-device control unit 211, an outlet controller 213, and an air-conditioner controller 215. The lighting-device control unit 211 controls the LED lighting devices 500 based on the information about the absolution position and the action (the orientation and the posture) of the person. More specifically, the lighting-device control unit 211 transmits a control signal to one of the LED lighting devices 500 that is near the received absolute position via the communication unit 201. This control signal sets an illuminating range of the LED lighting device 500 to be smaller than a predetermined range, and sets an illuminance of the same to a value higher than a predetermined threshold value when the person is in the sitting state. The illuminating range and the illuminance can be adjusted in this way to values appropriate for the person who is performing deskwork in the sitting state.

On the other hand, the lighting-device control unit 211 transmits to the LED lighting device 500 a control signal that sets the illuminating range and the illuminance to a range larger than the predetermined range and a value lower than the predetermined threshold value, respectively, via the communication unit 201 when the person is in the standing state. The illuminating range and the illuminance can thus be adjusted to the range and the value at which the user in the standing state can take a broad view of the room.

The outlet controller 213 controls power-on/off of the outlets of one of the outlet power strips 600 based on the information about the absolution position and the action (the orientation and the posture) of the person. More specifically, the outlet controller 213 transmits a control signal to a display device connected to one of the outlet power strips 600 that is near the received absolute position via the communication unit 201. This control signal causes an outlet to which the display device is connected of the outlet power strip 600 to be switched on when the person is in the sitting state and oriented to face the display device.

On the other hand, the outlet controller 213 transmits to the display device connected to the outlet power strip 600 a control signal that causes the outlet to which the display device is connected of the outlet power strip 600 to be switched off via the communication unit 201 when the person is in the standing state or oriented in a direction opposite to the display device.

The reason why the power control is performed depending on the orientation of the person relative to the display device is because relationship in orientation between the display device and the person matters greatly for the display device, and the display device can be judged to be being used when the person is oriented to face the display device. As for the posture of the person, the display device can be judged to be being used when the person is in the sitting state. In the present embodiment, the power control is performed in a manner to take actual usage of devices into consideration as described above, so that more appropriate control can be performed as compared with power control that is performed depending on only a distance from the device.

Furthermore, the outlet controller 213 according to the present embodiment performs power control of the desktop PC body and the display device in cooperation with personal identification of a user.

The air-conditioner controller 215 controls power-on/off of the air conditioners 700 based on the absolution position of the person. More specifically, the air-conditioner controller 215 transmits a control signal that switches on one of the air conditioners 700 associated with one of the groups that contains the desk of the received absolute position via the communication unit 201.

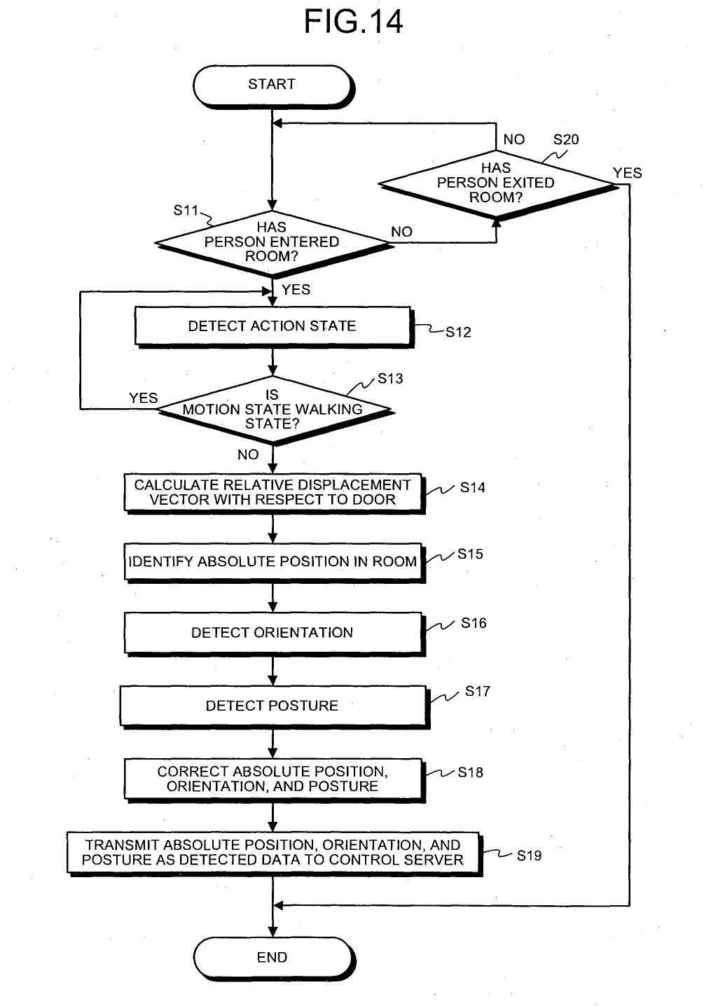

A detection process to be performed by the positioning server 100 configured as described above is described in detail below. FIG. 14 is a flowchart illustrating a procedure of the detection process to be performed by the positioning server 100 according to the present embodiment. The detection process along this flowchart is performed on each of the plurality of smartphones 300.

Aside from the detection process according to this flowchart, the positioning server 100 receives detection data (acceleration vectors, angular velocity vectors, and magnetic vectors) at predetermined intervals from the acceleration sensors, the angular velocity sensors, and the geomagnetic sensors mounted on the plurality of smartphones 300 or acceleration sensors, angular velocity sensors, and geomagnetic sensors that are independent from the smartphone 300 and also receives captured images from the plurality of monitoring cameras 400.

First, the positioning server 100 determines whether a person has entered the room which is the control target area based on captured images of an opened/closed door (Step S11). When it is detected that a person enters the room (Yes at Step S11), the action-state detecting unit 103 detects an action state of the entered person using the method described above (Step S12). The action-state detecting unit 103 determines whether the action state of the person is the walking state (Step S13). Over a period when the action state is the walking state (Yes at Step S13), the action-state detecting unit 103 repeatedly performs action state detection.

When the action state of the person is determined not to be the walking state (No at Step S13), the action-state detecting unit 103 determines that the action state of the person is the resting state. The position identifying unit 102 calculates a relative displacement vector with respect to the door which is the reference position using the method described above (Step S14).

The position identifying unit 102 identifies an absolute position of the person in the resting state based on the map data about the room stored in the storage unit 110 and the relative displacement vector with respect to the door (Step S15). Thus, the position identifying unit 102 can identify even at which one of the desks arranged in the room the person is. Accordingly, the position identifying unit 102 identifies the position of the person in the precision of the shoulder breadth (which is approximately 60 cm or smaller; more specifically, approximately 40 cm or smaller) of the person.

Subsequently, the action-state detecting unit 103 detects a direction (orientation) of the person relative to a display device as the action state of the person in the resting state using the magnetic vector received from the geomagnetic sensor (Step S16).

Subsequently, the action-state detecting unit 103 detects whether the person is in the sitting state or the standing state as the action state of the person using the method described above (Step S17). Thus, the action-state detecting unit 103 detects a vertical position of the person in the precision of approximately 50 cm or smaller (more specifically, approximately 40 cm or smaller).

The action-state detecting unit 103 may detect whether the action state of the person is any one of the squat action and the stand-up action, any one of the action of changing an orientation in the sitting state and the action of bringing the orientation back, any one of the action of turning eyes up in the sitting state and the action of turning eyes back, and any one of the action of turning eyes down in the sitting state and the action of turning eyes back.

Subsequently, the correcting unit 104 determines whether the identified absolute position, and the detected orientation and posture require correction as described above, and, if necessary, performs correction (Step S18).

The communication unit 101 transmits the absolute position, and the detected orientation and posture (in a case where correction is performed, the corrected absolute position, and the corrected orientation and posture) to the control server 200 as detected data (Step S19).

On the other hand, when no person entering is detected (No at Step S11), the positioning server 100 determines whether the person has exited the room which is the control target area based on captured images of an opened/closed door (Step S20). When it is detected that no person exits the room (No at Step S20), the process returns to Step S11; when it is detected that the person exits the room (Yes at Step S20), the detection process ends.

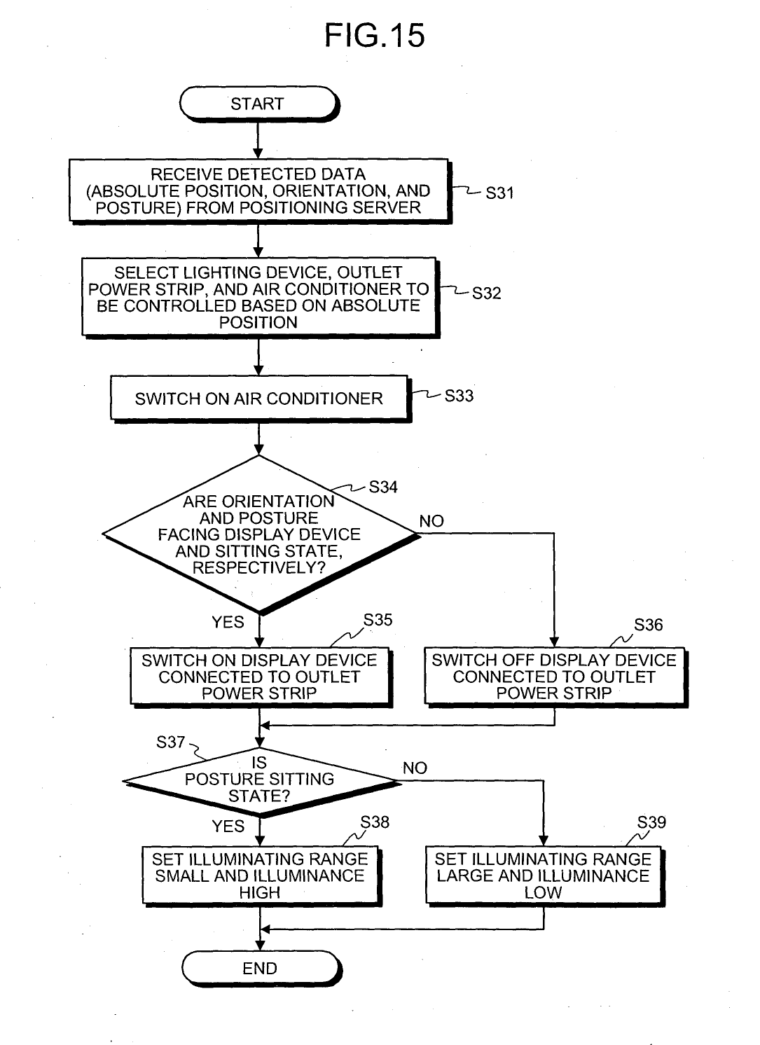

A device control process to be performed by the control server 200 is described below. FIG. 15 is a flowchart illustrating a procedure of the device control process according to the present embodiment.

First, the communication unit 201 receives the absolution position, the orientation, and the posture of the person as the detected data from the positioning server 100 (Step S31). Subsequently, the controllers 211, 213, and 215 of the device control unit 210 selects one of the LED lighting devices 500, one of the outlet power strips 600, and one of the air conditioners 700 as controlled devices based on the absolute position contained in the received detected data (Step S32).

More specifically, the lighting-device control unit 211 refers to the position data stored in the storage unit 220, thereby selecting one of the LED lighting devices 500 provided at a desk corresponding to the absolute position as a controlled device. The outlet controller 213 refers to the position data stored in the storage unit 220, thereby selecting one of the outlet power strips 600 provided near the desk corresponding to the absolute position as a controlled device. The air-conditioner controller 215 refers to the position data stored in the storage unit 220, thereby selecting one of the air conditioners 700 installed for the group that contains the desk corresponding to the absolute position as a controlled device.

Subsequently, the air-conditioner controller 215 issues a control signal that switches on the selected air conditioner 700 (step S33).

Subsequently, the outlet controller 213 determines whether the orientation and the posture contained in the received detected data are facing the display device and the sitting state, respectively (Step S34). When the person is oriented to face the display device in the sitting state (Yes at Step S34), the outlet controller 213 issues a control signal that switches on the outlet to which the display device is connected of the outlet power strip 600 selected at Step S32 (Step S35).

When the orientation is a direction opposite to the display device or when the posture is the standing state (No at Step S34), the outlet controller 213 issues a control signal that switches off the outlet to which the display device is connected of the outlet power strip 600 selected at Step S32 (Step S36).

Subsequently, the lighting-device control unit 211 determines whether the posture contained in the received detected data is the sitting state (Step S37). When the posture is the sitting state (Yes at Step S37), the lighting-device control unit 211 issues a control signal that sets an illuminating range of the LED lighting device 500 selected at Step S32 to be smaller than the predetermined range and an illuminance of the same to be higher than the predetermined threshold value (Step S38).

On the other hand, when the posture is the standing state (No at Step S37), the lighting-device control unit 211 issues a control signal that sets the illuminating range of the LED lighting device 500 selected at Step S32 to be larger than the predetermined range and the illuminance of the same to be lower than the predetermined threshold value (Step S39).

The controllers 211, 213, and 215 of the device control unit 210 may be configured to perform other control operations than those described above on the controlled devices.

The controllers 211, 213, and 215 of the device control unit 210 may be configured so as to control the controlled devices differently depending on which one of the squat action and the stand-up action, which one of the action changing an orientation in the sitting state and the action of bringing the orientation back, which one of the action (looking-up action) of turning the person's eyes up in the sitting state and the action of turning the eyes back, and which one of the action (looking-down action) of turning the person's eyes down in the sitting state and the action of turning the eyes back the action state of the person is.

Specific examples of such actions, controlled devices, and control methods are described below. Each of the actions is such an action that can occur when a worker is sitting at a desk. The to-be-controlled devices include a PC, a display device for the PC, a desk lamp, and a desk fan corresponding to an individual air conditioner.

For example, the outlet controller 213 can be configured to switch off an outlet to which power supply of the PC is connected when it is determined that a squat action of a worker at a desk lasts for a predetermined period of time or longer based on the received detected data. For another example, the device control unit 210 can be configured to include a mode control unit that controls modes of devices. The mode control unit can be configured to bring the display device of the PC into a standby mode.

The mode control unit can be configured to bring the PC to the standby mode in a case where, after the stand-up action is detected in a person in the sitting state, the standing state lasts for a predetermined period of time or longer. The outlet controller 213 can be configured to switch off an outlet to which power supply of the display device is connected concurrently when the PC is brought to the standby mode.

Examples of an employable control operation concerning an orientation-change action include the following. When, after a change in orientation of a head or an upper body is detected in a worker sitting at a desk, this action-changed state lasts for a predetermined period of time or longer, the worker is conceivably making conversation with another worker at an adjacent desk or the like. Accordingly, the outlet controller 213 and the mode control unit can be configured to put the PC, the display device, and a lighting device such as the desk stand on standby or off in this case, while the outlet controller 213 and the mode control unit switch on the PC, the display device, and the lighting device such as the desk stand when it is detected that the orientation of the worker has returned to its original state.

A worker that is reading a document at a desk conceivably performs the looking-down action, while the worker that is trying to come up with an idea or thinking conceivably performs the looking-up action. Accordingly, the outlet controller 213 and the mode control unit can be configured to perform control so as to bring the PC to the standby mode or switch off the display device off when the looking-up action or the looking-down action is continuously detected for a predetermined period of time or longer. Furthermore, the outlet controller 213 may be configured not to switch off the desk stand when the looking-down action is detected.

As described above, in the present embodiment, power control of devices is performed based on a position of a person that is identified in the precision of shoulder breadth, and detected orientation and posture of the person. Accordingly, power control of the devices can be performed with finer precision, and further power saving and energy saving can be achieved while maintaining comfort of workers and increasing efficiency of works.

In other words, according to the present embodiment, not only a person is detected, but also devices owned by the person, a lighting device, an air conditioner, an office automation device above a desk at which the person sits can be controlled on a person-by-person basis. Furthermore, information about power consumption of each person can be obtained.

Although conventional techniques enable implementation of what is called as “visual control” of power consumption of a building, an entire factory, or an entire office, the conventional techniques do not indicate what power saving action each individual should take. This makes it difficult to continue taking power saving actions because workers are less likely to be conscious of power saving unless otherwise a stringent situation, e.g., a situation where power consumption has exceeded a total target value or a power supply, occurs. However, according to the present embodiment, it is possible to implement further power saving and energy saving while maintaining comfort of workers and increasing efficiency of works.

The present embodiment also allows adding up power saving of automatically-controlled devices by performing cooperative control not only between persons and devices but also between devices.

Each of the positioning server 100 and the control server 200 according to the present embodiment includes a control apparatus such as a central processing unit (CPU), a storage such as a read only memory (ROM) and a random access memory (RAM), an external storage such as an HDD or a compact disk (CD) drive, a display device such as a monitor device, and an input device such as a keyboard and a mouse. Thus, each of the positioning server 100 and the control server 200 has a hardware structure that utilizes an ordinary computer.

Each of a detection program to be executed by the positioning server 100 according to the present embodiment and a control program to be executed by the control server 200 according to the present embodiment is preferably provided as a file of an installable format or an executable format recorded in a computer-readable recording medium such as a CD-ROM, a flexible disk (FD), a CD-R, or a digital versatile disk (DVD).

Each of the detection program to be executed by the positioning server 100 according to the present embodiment and the control program to be executed by the control server 200 according to the present embodiment can be configured so as to be stored in a computer connected to a network such as the Internet and provided by downloading through the network. Each of the detection program to be executed by the positioning server 100 according to the present embodiment and the control program to be executed by the control server 200 according to the present embodiment can be configured so as to be provided or distributed via a network such as the Internet.

Each of the detection program to be executed by the positioning server 100 according to the present embodiment and the control program to be executed by the control server 200 according to the present embodiment can be configured so as to be provided as being installed on the ROM or the like in advance.

The detection program to be executed by the positioning server 100 according to the present embodiment has a module configuration that includes the units (the communication unit 101, the position identifying unit 102, the action-state detecting unit 103, and the correcting unit 104) described above. From a viewpoint of actual hardware, the CPU (processor) reads out the detection program from the storage medium and executes it to load the units on a main memory, thereby generating the communication unit 101, the position identifying unit 102, the action-state detecting unit 103, and the correcting unit 104 on the main memory.

The control program to be executed by the control server 200 according to the present embodiment has a module configuration that includes the units (the communication unit 201, the power-consumption management unit 202, the lighting-device control unit 211, the outlet controller 213, and the air-conditioner controller 215) described above. From a viewpoint of actual hardware, the CPU (processor) reads out the control program from the storage medium and executes it to load the units on a main memory, thereby generating the communication unit 201, the power-consumption management unit 202, the lighting-device control unit 211, the outlet controller 213, and the air-conditioner controller 215 on the main memory.

### First Modification

The device control according to the present embodiment can be modified so as not to perform the power control of the display device that depends on the orientation of the person.

### Second Modification

The device control according to the present embodiment can be modified so as to perform neither the power control of the display device that depends on the orientation of the person nor the power control of the desktop PC body and the display device in cooperation with personal identification of the person.

### Third Modification

The device control according to the present embodiment can be modified so as to detect not only the standing state and the sitting state but also a posture related to the standing state and the sitting state and perform power control of the display device based on the detected posture.

### EXAMPLES

An example with the configuration according to the present embodiment is denoted as Example 1 below, while an example of the first modification, an example of the second modification, and an example of the third modification are denoted as Example 2, Example 3, and Example 4, respectively.

### Comparative Example 1

Total power consumption of power from the utility grid was measured in a condition where the device control according to the present embodiment was not performed at all. More specifically, the lighting devices were divided into groups (three groups in the present embodiment) each forming a lighting-device line. Wall switches near the doors provided for each of the lighting device groups were turned on and off at discretion of individual users. With regard to settings of the two air conditioners, the temperature and the humidity were fixed. Power-on/off, and direction and intensity of air to be blown were set at discretion of individual users using two remote controllers for the respective air conditioners. The outlets were constantly on. Full use of a power-saving mode of each of PCs, printing apparatuses, and the like was made. Eighteen users were encouraged to try to save power as much as possible.

### Comparative Example 2

White noise was intentionally added to each result of calculation of a position of each user in the device control according to the second modification, thereby creating a condition where an apparent positional detection precision is reduced to approximately 400 cm. This can be regarded as a pseudo device control system using an action sensor, which is configured by tailoring to a detection area of a general infrared action sensor.

### Experimental Results

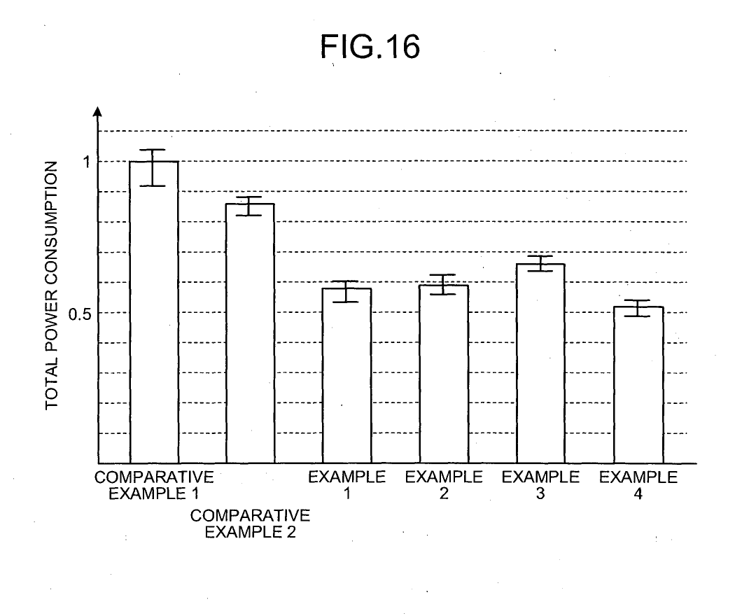

Total power consumption of successive five days (Monday to Friday) (30 days in total) were measured for each of the six conditions, or, more specifically, Examples 1 to 4 and Comparative Examples 1 and 2. This routine was performed two cycles (60 days in total). A result of comparison among total power consumptions at the different conditions is illustrated in FIG. 16.

Plotted are relative values of the total power consumptions of 10 days (5 days×2 cycles) at the different conditions normalized to a result at the condition of Comparative Example 1 as 1. Error bars represent variability of the total power consumptions of 10 days (5 days×2 cycles).

The result demonstrates that Example 1 has an effect of reducing total power consumption by approximately 40%. The result also demonstrates that the reduction effect brought about by Example 1 is superior than that by the functionally-fabricated pseudo action sensor system. Thus, high positioning precision of Example 1 is verified to be effective in power saving control. In this experiment, Example 1 is not verified to be superior in power reducing effect to Example 2. However, a situation where displays were obviously unnecessarily lit on while persons sitting back to back were making conversation face to face was observed during the experiment for Example 2. Accordingly, the inventors construe that Example 1 can yield a result that is different from and superior to a result of Example 2 in other circumstances.

The effect of Example 1 in power reduction can be concluded to be superior to some extent to that of Example 3. Accordingly, superiority of the system of Example 1 capable of achieving power saving that cannot be achieved by control means that utilizes an action sensor or the like but does not have a personal identification function is partially verified. The effect of Example 4 in power reduction can be concluded to be superior to some extent to that of Example 1. Accordingly, superiority of the system of Example 4 capable of implementing control based on posture information is partially verified.

Examples 1 to 4 allow analyzing information about a position of a person and information about power consumption of devices to be controlled for the person using data stored in the server, thereby obtaining a ratio of power consumption of each individual to total power consumption. This ratio can be displayed on a cellular phone and/or a PC. In this way, Examples 1 to 4 produce an effect of adding power saving by encouraging individual persons to act so as to save power, which has been unattainable only by conventional visualization of power consumption, in addition to the power saving effect by automatic control. Furthermore, the power saving by automatic control is advantageous at least in that it does not impair efficiency of work because the control obviates the necessity for workers to be constantly conscious of power saving.

The power control system based on Examples 1 to 4 can be modified in various manners. It is expected that each of them can provide a power saving effect that is superior to that of conventional power saving techniques.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1-17. (canceled)

18. A device control system comprising:
a positioning apparatus configured to detect a position and an action state of at least one person; and
a control apparatus configured to control a device, the control apparatus being connected to the positioning apparatus; wherein
the positioning apparatus includes
a first receiver configured to receive data from at least one sensor that is carried by the person, the data indicating the position and the action state of the person, and
a transmitter configured to transmit the position and the action state to the control apparatus based on the data;
the control apparatus includes
a second receiver configured to receive the position and the action state of the person from the positioning apparatus, and
a device control unit configured to control the device based on the position and the action state of the person;
the data includes an acceleration vector and an angular velocity vector received from the at least one sensor; and
the positioning apparatus further includes an action-state detecting unit that detects whether the action state of the person is a resting state or a walking state based on the acceleration vector and the angular velocity vector.

19. The device control system according to claim 18, wherein when the action state is the resting state, the action-state detecting unit detects an orientation of the person relative to the device based on the acceleration vector and the angular velocity vector.

20. The device control system according to claim 18, wherein when the action state is the resting state, the action-state detecting unit detects a posture of the person based on the acceleration vector and the angular velocity vector.

21. The device control system according to claim 20, wherein the action-state detecting unit further detects whether the posture of the person is a standing state or a sitting state based on the acceleration vector and the angular velocity vector.

22. The device control system according to claim 21, wherein the action-state detecting unit further detects whether an action of the person is a stand-up action or a squat action based on variation with time of a horizontal angular velocity component of the angular velocity vector.

23. The device control system according to claim 19, wherein the action-state detecting unit further detects an orientation-change action as an action of the person based on variation with time of a vertical angular velocity component of the angular velocity vector.

24. The device control system according to claim 23, wherein
the sensor includes a sensor worn at a head of the person and a sensor worn at a waist of the person, and
the action-state detecting unit detects whether the orientation-change action is an action of changing an orientation of the head or an action of changing an orientation of an entire body of the person based on variation with time of vertical angular velocity components of angular velocity vectors received from the sensors at the head and the waist.

25. The device control system according to claim 24, wherein the action-state detecting unit further detects an action of turning eyes up and an action of turning eyes down as the action of the person based on variation with time of a horizontal angular velocity component of the angular velocity vector received from the sensor at the head.

26. The device control system according to claim 18, wherein the positioning apparatus further includes a position identifying unit that identifies an absolute position of the person based on an acceleration vector, an angular velocity vector, and a geomagnetic vector received from the sensor.

27. The device control system according to claim 18, wherein
the first receiver receives an image of a control target area from an image capturing device, and
the positioning apparatus further includes a correcting unit configured to correct the position and the action state of the person based on the captured image.

28. The device control system according to claim 18, wherein the device to be controlled by the device control unit includes a lighting device, an outlet power strip to which a power supply of an electrical device is connected, and an air conditioner.

29. The device control system according to claim 28, wherein the device control unit controls an illuminating range and an illuminance of the lighting device.

30. The device control system according to claim 28, wherein the device control unit controls power on and off of the electrical device.

31. The device control system according to claim 28, wherein the device control unit controls a direction and intensity of air to be blown by the air conditioner.

32. A device control method to be performed by a device control system that includes a positioning apparatus configured to detect a position and an action state of at least one person, and a control apparatus configured to control a device, the control apparatus being connected to the positioning apparatus, the device control method comprising:
receiving, by the positioning apparatus, data from at least one sensor that is carried by the person, the data indicating the position and the action state of the person;
transmitting, by the positioning apparatus, the position and the action state to the control apparatus based on the data;
receiving, by the control apparatus, the position and the action state of the person from the positioning apparatus; and
controlling, by the control apparatus, the device based on the position and the action state of the person,
wherein the data includes an acceleration vector and an angular velocity vector received from the at least one sensor, and
the device control method further comprises detecting whether the action state of the person is a resting state or a walking state based on the acceleration vector and the angular velocity vector.

33. A non-transitory computer-readable recording medium including an executable program stored thereon, wherein the program instructs a computer that detects a position and an action state of at least one person, to perform:
receiving data from at least one sensor that is carried by the person, the data indicating the position and the action state of the person; and
transmitting the position and the action state to a control apparatus that is connected to the computer and controls a device, based on the data,
wherein the data includes an acceleration vector and an angular velocity vector received from the at least one sensor, and
the program further instructs the computer to perform detecting whether the action state of the person is a resting state or a walking state based on the acceleration vector and the angular velocity vector.
